(19) United States
(12) Patent Application Publication
(10) Pub. No.: US 2014/0014853 A1
(43) Pub. Date: Jan. 16, 2014

(54) ULTRAVIOLET IRRADIATION DEVICE

(71) Applicant: Kabushiki Kaisha Toshiba, Tokyo (JP)

(72) Inventors: Shinji Kobayashi, Kanagawa-ken (JP); Norimitsu Abe, Kanagawa-ken (JP); Akihiko Shirota, Tokyo (JP); Kenji Takeuchi, Tokyo (JP); Takahiro Soma, Kanagawa-ken (JP)

(73) Assignee: KABUSHIKI KAISHA TOSHIBA, Tokyo (JP)

(21) Appl. No.: 14/030,894

(22) Filed: Sep. 18, 2013

Related U.S. Application Data
(63) Continuation of application No. 13/561,927, filed on Jul. 30, 2012.

(30) Foreign Application Priority Data
Sep. 15, 2011 (JP) 2011-201839

(51) Int. Cl. C02F 1/32

(52) U.S. Cl. CPC C02F 1/325
USPC 250/436

(57) ABSTRACT

An ultraviolet irradiation device includes a treatment vessel, an ultraviolet irradiation member, and a support member. The treatment vessel has a water inlet and a water outlet and through which water to be treated as a treatment target flows in a first direction from the water inlet toward the water outlet, the treatment vessel receiving the water to be treated through the water inlet and discharging the water to be treated through the water outlet. The ultraviolet irradiation member is provided inside the treatment vessel along a second direction crossing the first direction and which irradiates the water to be treated flowing through the treatment vessel with an ultraviolet ray. The support member is provided inside the treatment vessel along the second direction with both end portions of the support member being firmly fixed to wall surfaces of the treatment vessel.

### CROSS-REFERENCE TO RELATED APPLICATION(S)

This application is a continuation of U.S. patent application Ser. No. 13/561,927, filed on Jul. 30, 2012, which is based upon and claims the benefit of priority from Japanese Patent Application No. 2011-201839, filed on Sep. 15, 2011, the entire contents of these applications are incorporated herein by reference.

### FIELD

Embodiments of the present invention relate to an ultraviolet irradiation device.

### BACKGROUND

Heretofore, ultraviolet rays have been used for sterilizing and disinfecting water to be treated (hereinafter, referred to as “treatment target water”) such as sewages, tap water and underground water, for deodorizing and decolorizing industrial water, for bleaching pulp, as well as for sterilizing medical equipment, and so on.

JP, P2011-131138A discloses an ultraviolet irradiation device including a treatment vessel, ultraviolet sensors, and a control device. The treatment vessel includes: a water inlet through which raw water flows in; ultraviolet lamps which irradiate the raw water having flowed in with ultraviolet rays, and a water outlet through which the raw water irradiated with the ultraviolet rays is discharged. The ultraviolet sensors measure the amounts of the ultraviolet rays emitted from the ultraviolet lamps. The control device controls the turnon and turnoff of the ultraviolet lamps.

Meanwhile, in the above ultraviolet irradiation device using ultraviolet rays, the treatment vessel, which treatment target water flows through, may be deformed due to a pressure increase in the treatment vessel. Such deformation breaks protection tubes housing the ultraviolet lamps therein, thus resulting in the scattering of pieces of glass within the water. Further, the breakage of the protection tubes may lead to breakage of the ultraviolet lamps. As a result, the electrodes, gas, and the like enclosed inside the ultraviolet lamps flow out.

### BRIEF DESCRIPTION OF DRAWINGS

FIG. 1 is a flowchart showing the procedure of treatment performed in a tap water treatment system;

FIG. 2 is an external view of an ultraviolet irradiation device according to a first embodiment;

FIG. 3 is a vertical cross-sectional view of a treatment vessel;

FIG. 4 is a horizontal cross-sectional view of the treatment vessel;

FIG. 5 is a horizontal cross-sectional view of a treatment vessel;

FIG. 6 is a horizontal cross-sectional view of a treatment vessel;

FIG. 7 is a vertical cross-sectional view of a treatment vessel;

FIG. 8 is a vertical cross-sectional view of a treatment vessel; and

FIG. 9 is a vertical cross-sectional view of a treatment vessel.

### DETAILED DESCRIPTION

According to an embodiment, an ultraviolet irradiation device includes: a treatment vessel which has a water inlet and a water outlet and through which water to be treated as a treatment target flows in a first direction from the water inlet toward the water outlet, the treatment vessel receiving the water to be treated through the water inlet and discharging the water to be treated through the water outlet; an ultraviolet irradiation member which is provided inside the treatment vessel along a second direction crossing the first direction and which irradiates the water to be treated flowing through the treatment vessel with an ultraviolet ray; and a support member which is provided inside the treatment vessel along the second direction with both end portions of the support member being firmly fixed to wall surfaces of the treatment vessel.

### First Embodiment

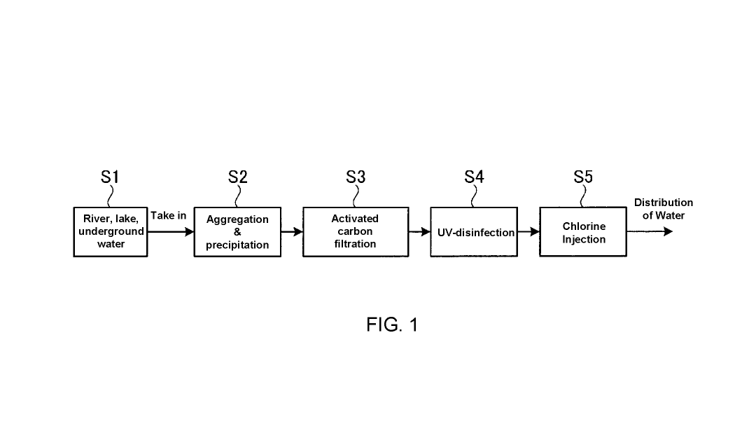

To begin with, an overview of the flow of treatment performed in a tap water treatment system will be described with reference to FIG. 1. FIG. 1 is a flowchart showing the procedure of the treatment performed in the tap water treatment system. First, raw water (treatment target water) is taken from a river, a lake, or underground water (step S1). Then, the taken raw water is introduced into an aggregation-precipitation vessel, in which an aggregation agent is added to the raw water to thereby effect aggregation and precipitation of minute particles (step S2). Then, supernatant water in the aggregation-precipitation vessel is sent to an activated carbon filter vessel, in which foreign substances are filtered out (step S3). Then, the filtered water is sent to an ultraviolet irradiation device, in which the filtered water is irradiated with ultraviolet rays (step S4). Then, the UV-disinfected water is sent to a chlorine introduction vessel, in which chlorine is introduced into the UV-disinfected water (step S5). After step S5, the water is supplied to ordinary households, business facilities, and the like.

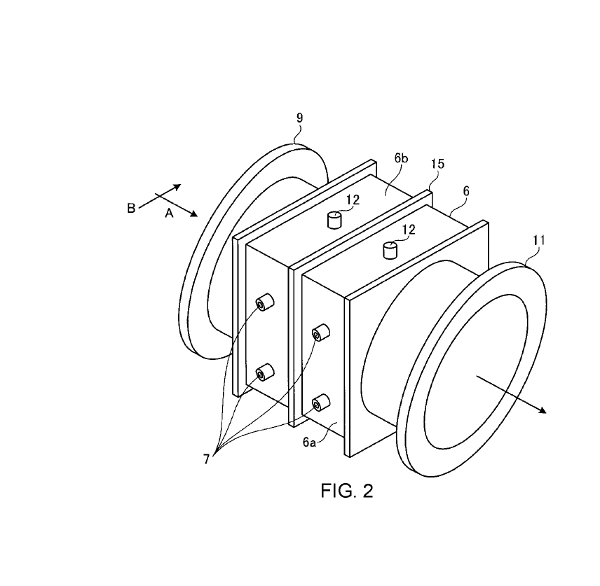

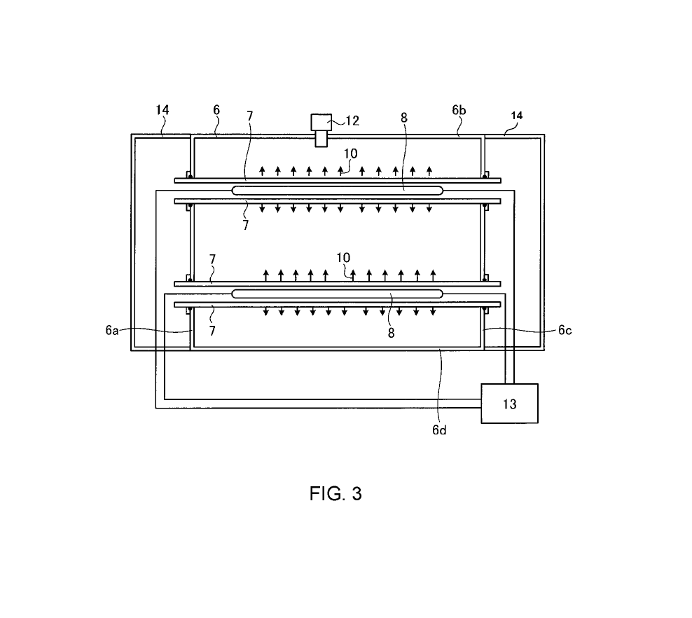

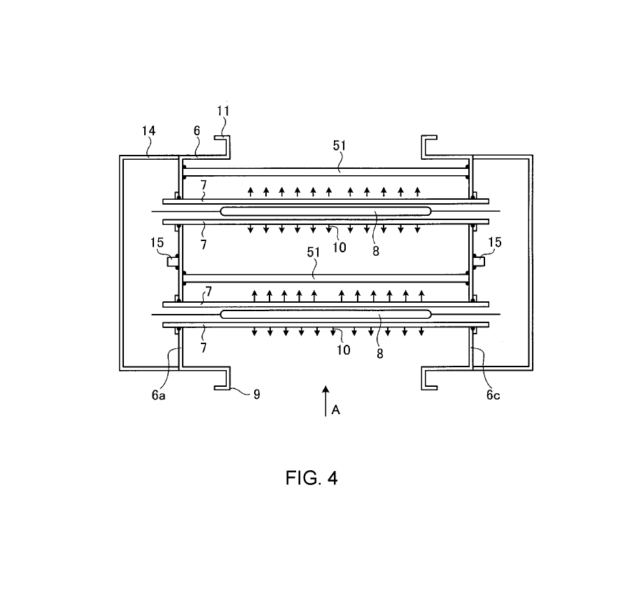

Next, the ultraviolet irradiation device of this embodiment will be described. FIG. 2 is an external view of the ultraviolet irradiation device according to the first embodiment. FIG. 3 is a vertical cross-sectional view of a treatment vessel thereof. FIG. 4 is a horizontal cross-sectional view of the treatment vessel. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7; ultraviolet monitor windows 12; protection covers 14; ribs 15; and support bars 51.

The treatment vessel 6 is formed in a rectangular parallelepiped shape, and the treatment target water to be subjected to sterilization, disinfection, and inactivation flows through the treatment vessel 6. Moreover, the treatment vessel 6 has a water inlet through which to receive the treatment target water and a water outlet through which to discharge the treatment target water after the treatment. These water inlet and outlet are formed in given opposite walls of the treatment vessel 6, respectively. Moreover, the water supply port 9 is connected to the water inlet of the treatment vessel 6, and the water discharge port 11 is connected to the water outlet of the treatment vessel 6. The treatment target water flows through the treatment vessel 6 by flowing in a direction from the water inlet (water supply port 9) toward the water outlet (water discharge port 11), which is a direction A in FIG. 2. Note that a horizontal direction perpendicular to the direction A will be referred to as a direction B. Moreover, FIG. 3 is across-sectional view taken along a line crossing one of the protection tubes 7 (described next) perpendicularly to the direction A in FIG. 2.

Each of the protection tubes 7 is formed of a dielectric body capable of transmitting ultraviolet rays and is formed, for example, of silica glass. Moreover, as shown in FIGS. 3 and 4, inside the protection tubes 7, there are housed the ultraviolet lamps 8, respectively, which emit ultraviolet rays to the treatment target water flowing through the treatment vessel 6 from the water inlet to the water outlet. Wires are connected respectively to both end portions of the ultraviolet lamps 8, and the remaining ends of the wires are connected to an electronic stabilizer 13 which supplies power to the ultraviolet lamps 8.

Meanwhile, four protection tubes 7 are provided inside the treatment vessel 6 along a direction crossing the direction from the water inlet toward the water outlet. Specifically, in this embodiment, as shown in FIGS. 2 to 4, four protection tubes 7 are provided inside the treatment vessel 6 and penetrate through a side face 6a and its opposite face 6c of the treatment vessel 6 in the direction B which is a horizontal direction perpendicular to the direction A. Note that each protection tube 7 and its ultraviolet lamp 8 constitute an ultraviolet irradiation member.

Two ultraviolet monitor windows 12 are provided in an upper face 6b of the treatment vessel 6 which is perpendicular to the side face 6a. The ultraviolet monitor windows 12 are equipped with ultraviolet monitors which monitor the amounts of ultraviolet rays from the ultraviolet lamps 8.

The protection covers 14 shut off ultraviolet rays 10 emitted from the ultraviolet lamps 8 and are provided on the outer sides of the side faces 6a and 6c of the treatment vessel 6 (see FIGS. 3 and 4). Note that the protection covers 14 are omitted in FIG. 2.

The ribs 15 suppress deformation of the treatment vessel 6 due to an increase in internal pressure. The ribs 15 are provided on the outer circumference of the treatment vessel 6, i.e. the side face 6a, the side face 6c, the upper face 6b, and a lower face 6d opposed to the upper face 6b. Moreover, the ribs 15 are provided on the treatment vessel 6 in the vicinity of the center thereof in the direction A.

The support bars 51 suppress the deformation of the treatment vessel 6. The support bars 51 have a bar shape and are provided inside the treatment vessel 6 along the direction the protection tubes 7 extend (the direction crossing the direction A). Specifically, in this embodiment, four support bars 51 are provided along the direction parallel to the protection tubes 7 (direction B). Moreover, both end portions of each support bar 51 are firmly fixed to the inner walls of the side faces 6a and 6c of the treatment vessel 6, respectively.

Now, the support bars 51 will be described further. The protection tubes 7 are formed of silica glass or the like as mentioned above and therefore have low elasticity. Thus, the protection tubes 7 provided to the treatment vessel 6 may break when the treatment vessel 6 becomes deformed due to a pressure. Moreover, the breakage of the protection tubes 7 may lead to breakage of the ultraviolet lamps 8 housed therein. However, the support bars 51 suppress the deformation of the treatment vessel 6 due to a pressure increase. As a result, the breakage of the protection tubes 7 and the ultraviolet lamps 8 can be prevented.

Moreover, the four support bars 51 are provided to the four protection tubes 7, respectively. Each support bar 51 is provided closer to the water outlet (the water discharge port 11) in the direction A than the corresponding protection tube 7 is. Specifically, in a case where the treatment target water flows from the water supply port 9 toward the water discharge port 11, the support bar 51 is disposed downstream of the protection tube 7. In other words, the support bar 51 is disposed between the protection tube 7 and the water outlet in a first direction.

In a case where the support bar 51 is disposed upstream (water supply port 9 side) of the protection tube 7 with respect to the flow of the treatment target water, the support bar 51 generates turbulence in the treatment target water before ultraviolet rays from the ultraviolet lamp 8 are emitted to the treatment target water. For this reason, the support bar 51 is disposed downstream of the protection tube 7 so that the ultraviolet rays can be irradiated to the treatment target water before turbulence is generated.

Moreover, an outside diameter D₀ of each support bar 51 satisfies (formula 1) so that turbulence generated by the flow of the treatment target water will not vibrate and break the support bar 51.

Vr<1 (formula 1)

Reduced flow velocity (reference): Vr=U/(fₙ×D₀)

Average reference flow velocity: U=Qₘₐₓ/S_{d}

Natural Frequency: fₙ=(λ²)/(2πL²)×√(EI/(m+m_{w}))

Outside diameter of support member: D₀

Maximum flow velocity: Qₘₐₓ

Cross-sectional area of flow passage: S_{d}

Eigen value: λ=3.1415

(Formulas for natural frequency and mode shape, R. D. Blevins, Krieger Publishing company)

Young's modulus of material of support member: E

Second area moment: I=π/64 (D₀⁴)

Length of support member: L

Mass per unit: m=Sρₛ

Removed mass per unit: m_{w}=S_{w}ρ_{w}

Cross-sectional area of support member: S

Density: ρₛ

Removed area: S_{w}=π(D₀/2)²

Water Density: ρ_{w}

In the ultraviolet irradiation device of this embodiment configured as described above, the treatment target water flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the first embodiment, the four support bars 51 having the predetermined outside diameter are each disposed in parallel to the protection tubes 7 on a side closer to the water discharge port 11 (downstream side) than the corresponding protection tube 7 is. Thus, the support bars 51 suppress the deformation of the treatment vessel 6 due to a pressure increase inside the treatment vessel 6. Accordingly, the ultraviolet irradiation device of the first embodiment can prevent the breakage of the protection tubes 7 housing the ultraviolet lamps 8.

### Second Embodiment

While the ultraviolet irradiation device of the first embodiment uses bar-shaped support members, an ultraviolet irradiation device of this embodiment uses pipe-shaped support members.

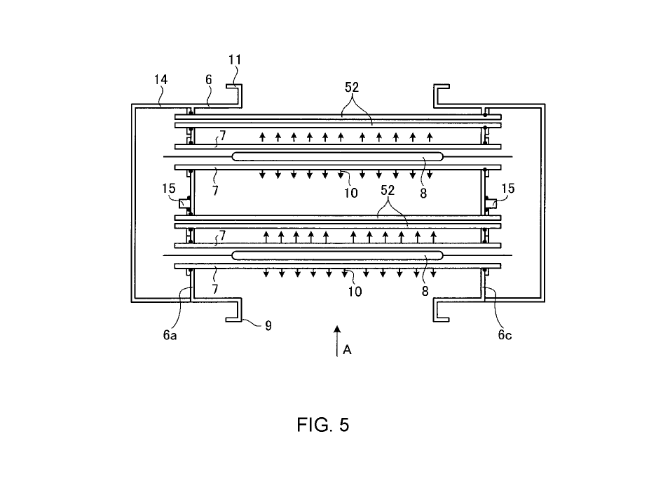

The external appearance of the ultraviolet irradiation device of this embodiment is similar to that of the first embodiment (see FIG. 2). FIG. 5 is a horizontal cross-sectional view of a treatment vessel thereof. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7; ultraviolet monitor windows 12; protection covers 14; ribs 15; and support pipes 52. Note that the treatment vessel 6, the water supply port 9, the water discharge port 11, the protection tubes 7, the ultraviolet monitor windows 12, the protection covers 14, and the ribs 15 are the same as those of the first embodiment in terms of configuration and function, and therefore their descriptions are omitted.

The support pipes 52 suppress the deformation of the treatment vessel 6. The support pipes 52 have a pipe shape (cylindrical shape) and are provided inside the treatment vessel 6 along the direction the protection tubes 7 extend (the direction crossing the direction A). Specifically, in this embodiment, four support pipes 52 are provided along the direction parallel to the protection tubes 7 (direction B). Moreover, both end portions of each support pipe 52 penetrate through and are firmly fixed to the side faces 6a and 6c of the treatment vessel 6, respectively. Such support pipes 52 suppress the deformation of the treatment vessel 6 due to a pressure increase. As a result, the breakage of the protection tubes 7 and the ultraviolet lamps 8 can be prevented.

Moreover, the four support pipes 52 are provided to the four protection tubes 7, respectively. Each support pipe 52 is provided closer to the water outlet (the water discharge port 11) in the direction A than the corresponding protection tube 7 is. Specifically, in a case where the treatment target water flows from the water supply port 9 toward the water discharge port 11, the support pipe 52 is disposed downstream of the protection tube 7. In other words, the support pipe 52 is disposed between the protection tube 7 and the water outlet in the first direction. Like the first embodiment, this is for irradiating ultraviolet rays to the treatment target water before turbulence is generated.

Moreover, an outside diameter D₀ and a thickness t of each support pipe 52 satisfy (formula 2) so that turbulence generated by the flow of the treatment target water will not vibrate and break the support pipe 52.

Vr<1 (formula 2)

Reduced flow velocity (reference): Vr=U/(fₙ×D₀)

Average reference flow velocity: U=Qₘₐₓ/S_{d}

Natural Frequency: fₙ=(λ²)/(2πL²)×√(EI/(m+m_{w}))

Outside diameter of support member: D₀

Maximum flow velocity: Qₘₐₓ

Cross-sectional area of flow passage: S_{d}

Eigen value: λ=3.1415

(Formulas for natural frequency and mode shape, R. D. Blevins, Krieger Publishing company)

Young's modulus of material of support member: E

Second area moment: I=π/64 (D₀⁴)

Length of support member: L

Mass per unit: m=Sρₛ

Removed mass per unit: m_{w}=S_{w}ρ_{w}

Cross-sectional area of support member: S=π(D₀/2)²−π(Dᵢₙ/2)²

Inside diameter of support member: Dᵢₙ=D₀−2 t

Thickness of support member: t

Density: ρₛ

Removed area: S_{w}=π(D₀/2)²

Water Density: ρ_{w}

In the ultraviolet irradiation device of this embodiment configured as described above, the treatment target water flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the second embodiment, the four support pipes 52 having the predetermined outside diameter and thickness are each disposed in parallel to the protection tubes 7 on a side closer to the water discharge port 11 (downstream side) than the corresponding protection tube 7 is. Thus, the support pipes 52 suppress the deformation of the treatment vessel 6 due to a pressure increase inside the treatment vessel 6. Accordingly, the ultraviolet irradiation device of the second embodiment can prevent the breakage of the protection tubes 7 housing the ultraviolet lamps 8.

### Third Embodiment

In this embodiment, pipes with wires penetrating therethrough serve also as the support members.

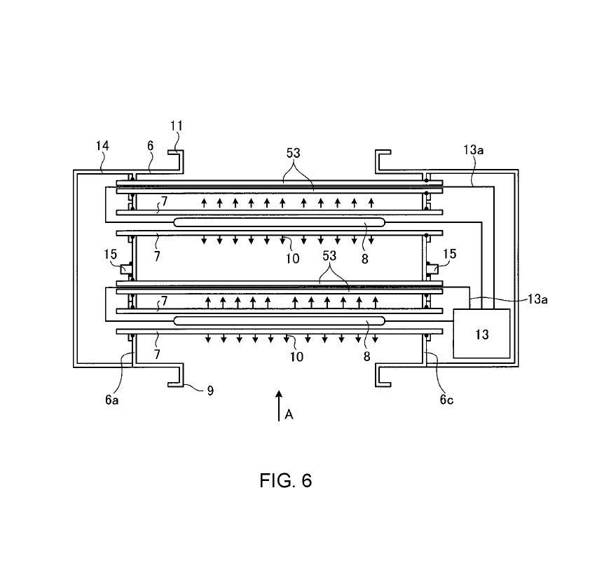

The external appearance of an ultraviolet irradiation device of this embodiment is similar to that of the first embodiment (see FIG. 2). FIG. 6 is a horizontal cross-sectional view of a treatment vessel thereof. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7; ultraviolet monitor windows 12; protection covers 14; ribs 15; and pipes 53. Note that the treatment vessel 6, the water supply port 9, the water discharge port 11, the protection tubes 7, the ultraviolet monitor windows 12, the protection covers 14, and the ribs 15 are to the same as those of the first embodiment in terms of configuration and function, and therefore their descriptions are omitted.

The pipes 53 have a pipe shape (cylindrical shape) and are provided inside the treatment vessel 6 along the direction the protection tubes 7 extend (the direction crossing the direction A). Specifically, in this embodiment, four pipes 53 are provided along the direction parallel to the protection tubes 7 (direction B). Moreover, both end portions of each pipe 53 penetrate through and are firmly fixed to the side faces 6a and 6c of the treatment vessel 6, respectively.

There are wires 13a connected at one end to end portions of the ultraviolet lamps 8, respectively. These wires 13a penetrate through the pipes 53, respectively. Moreover, the wires 13a are connected at the other end to an electronic stabilizer 13 which supplies power to the ultraviolet lamps 8. Note that the electronic stabilizer 13 of this embodiment is installed inside one of the protection covers 14.

Moreover, the pipes 53 suppress the deformation of the treatment vessel 6, meaning that the pipes 53 suppress the deformation of the treatment vessel 6 due to a pressure increase. As a result, the breakage of the protection tubes 7 and the ultraviolet lamps 8 can be prevented. Specifically, each pipe 53 allows its corresponding wire 13a to penetrate therethrough and also functions as a support member which suppresses the deformation of the treatment vessel 6.

Moreover, the four pipes 53 are provided to the four protection tubes 7, respectively. Each pipe 53 is provided closer to the water outlet (the water discharge port 11) in the direction A than the corresponding protection tube 7 is. Specifically, in a case where the treatment target water flows from the water supply port 9 toward the water discharge port 11, the pipe 53 is disposed downstream of the protection tube 7. In other words, the pipe 53 is disposed between the protection tube 7 and the water outlet in the first direction. Like the first embodiment, this is for irradiating ultraviolet rays to the treatment target water before turbulence is generated.

Moreover, an outside diameter D₀ and a thickness t of each pipe 53 satisfy (formula 2) mentioned above (see the second embodiment) so that turbulence generated by the flow of the treatment target water will not vibrate and break the pipe 53.

In the ultraviolet irradiation device of this embodiment configured as described above, the treatment target water flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the third embodiment, the four pipes 53 having the predetermined outside diameter and thickness are each disposed in parallel to the protection tubes 7 on a side closer to the water discharge port 11 (downstream side) than the corresponding protection tube 7 is. Thus, the pipes 53 form passages which the wires 13a for supplying power to the ultraviolet lamps 8 penetrate through and also suppress the deformation of the treatment vessel 6 due to a pressure increase inside the treatment vessel 6. Accordingly, the ultraviolet irradiation device of the third embodiment can prevent the breakage of the protection tubes 7 housing the ultraviolet lamps 8.

### Fourth Embodiment

While bar-shaped support bars are firmly fixed to the treatment vessel as the support members in the ultraviolet irradiation device of the first embodiment, an ultraviolet irradiation device of this embodiment uses support members of a rectangular plate shape.

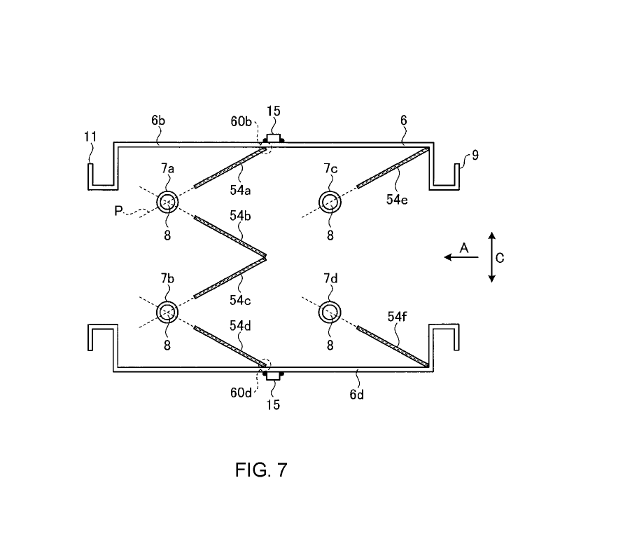

The external appearance of the ultraviolet irradiation device of this embodiment is similar to that of the first embodiment (see FIG. 2). FIG. 7 is a vertical cross-sectional view of a treatment vessel thereof. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7 (7a, 7b, 7c, and 7d); ultraviolet monitor windows 12; protection covers 14; ribs 15; and support plates 54 (54a, 54b, 54c, 54d, 54e, and 54f). Note that the treatment vessel 6, the water supply port 9, the water discharge port 11, the protection tubes 7, the ultraviolet monitor windows 12, the protection covers 14, and the ribs 15 are the same as those of the first embodiment in terms of configuration and function, and therefore their descriptions are omitted. Note also that since four protection tubes 7 are provided, they are denoted by 7a, 7b, 7c, and 7d, respectively. Likewise, since six support plates 54 are provided, they are denoted by 54a, 54b, 54c, 54d, 54e, and 54f, respectively.

The support plates 54 suppress the deformation of the treatment vessel 6. The support plates 54 are formed in a rectangular plate shape and are provided inside the treatment vessel 6 with their longitudinal direction being set in the direction the protection tubes 7 extend (the direction crossing the direction A). Specifically, in this embodiment, the six support plates 54 are provided such that their long sides extend in the direction parallel to the protection tubes 7 (direction B). Moreover, both short sides of each support plate 54 are firmly fixed to the inner walls of the side faces 6a and 6c of the treatment vessel 6 (see FIG. 3), respectively.

One long side of the support plate 54a is firmly fixed to the inner wall of the upper face 6b (which is parallel to the direction A and perpendicular to the side faces 6a and 6c) at a portion 60b in the vicinity of the center thereof in the direction A. Moreover, the support plate 54a is disposed on a plane crossing the center axis of the protection tube 7a (P in FIG. 7). In other words, the support plate 54a is disposed extending toward the center axis of the protection tube 7a from the upper face 6b of the treatment vessel 6. Note that inside the treatment vessel 6, the protection tube 7a is disposed closer to the water outlet in the direction A than the support plate 54a is.

In addition, one long side of the support plate 54d is firmly fixed to the inner wall of the lower face 6d (which is parallel to the direction A and perpendicular to the side faces 6a and 6c) at a portion 60d in the vicinity of the center thereof in the direction A. Moreover, the support plate 54d is disposed on a plane crossing the center axis of the protection tube 7b. In other words, the support plate 54d is disposed extending toward the center axis of the protection tube 7b from the lower face 6d of the treatment vessel 6. Note that inside the treatment vessel 6, the protection tube 7b is disposed closer to the water outlet in the direction A than the support plate 54d is.

In addition, one long side of the support plate 54e is firmly fixed to the inner wall (corner) of the upper face 6b in the vicinity of the water supply port 9. Moreover, the support plate 54e is disposed on a plane crossing the center axis of the protection tube 7c. In other words, the support plate 54e is disposed extending toward the center axis of the protection tube 7c from the upper face 6b of the treatment vessel 6. Note that inside the treatment vessel 6, the protection tube 7c is disposed closer to the water outlet in the direction A than the support plate 54e is.

In addition, one long side of the support plate 54f is firmly fixed to the inner wall (corner) of the lower face 6d in the vicinity of the water supply port 9. Moreover, the support plate 54f is disposed on a plane crossing the center axis of the protection tube 7d. In other words, the support plate 54f is disposed extending toward the center axis of the protection tube 7d from the lower face 6d of the treatment vessel 6. Note that inside the treatment vessel 6, the protection tube 7d is disposed closer to the water outlet in the direction A than the support plate 54f is.

In addition, one long side of the support plate 54b is disposed in the vicinity of the center of the inside of the treatment vessel 6. Moreover, the support plate 54b is disposed on a plane crossing the center axis of the protection tube 7a. In other words, the support plate 54b is disposed extending toward the center axis of the protection tube 7a from the vicinity of the center of the treatment vessel 6.

In addition, one long side of the support plate 54c is disposed in the vicinity of the center of the inside of the treatment vessel 6. Moreover, the support plate 54c is disposed on a plane crossing the center axis of the protection tube 7b. In other words, the support plate 54c is disposed extending toward the center axis of the protection tube 7b from the vicinity of the center of the treatment vessel 6.

These support plates 54 suppress the deformation of the treatment vessel 6 due to a pressure increase. As a result, the breakage of the protection tubes 7 and the ultraviolet lamps 8 can be prevented. Moreover, each support plate 54 is disposed on the corresponding plane crossing the center axis of the given protection tube 7. Hence, the support plate 54 is disposed without blocking ultraviolet rays emitted by the corresponding ultraviolet lamp 8. Further, the support plate 54 can guide the treatment target water around the protection tube 7 toward the protection tube 7.

In the ultraviolet irradiation device of this embodiment configured as described above, the treatment target water flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the fourth embodiment, each of the six support plates 54 formed in a rectangular plate shape has its longitudinal direction being set in parallel to the protection tubes 7 and is disposed on the corresponding plane crossing the center axis of the given protection tube 7. Thus, the support plates 54 suppress the deformation of the treatment vessel 6 due to a pressure increase inside the treatment vessel 6. Accordingly, the ultraviolet irradiation device of the fourth embodiment can prevent the breakage of the protection tubes 7 housing the ultraviolet lamps 8.

Further, one long side of the support plate 54a is firmly fixed to the upper face 6b of the treatment vessel 6 in the vicinity of the center thereof, and one long side of the support plate 54d is firmly fixed to the lower face 6d of the treatment vessel 6 in the vicinity of the center thereof. Accordingly, deformation of the treatment vessel 6 in a direction C in FIG. 7 can be suppressed. Moreover, since each support plate 54 is disposed on the corresponding plane crossing the center axis of the given protection tube 7, the treatment target water around the protection tube 7 can be directed to the protection tube 7. Accordingly, the treatment target water can be irradiated with a larger amount of ultraviolet rays than otherwise.

### Fifth Embodiment

In this embodiment, shafts which prevent rotation of members serve also as the support members.

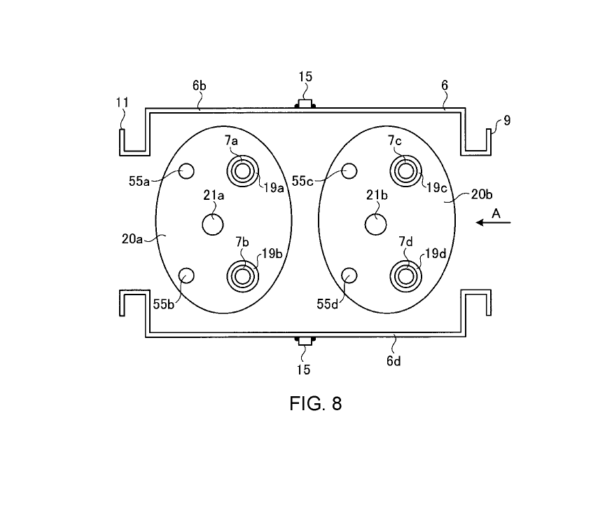

The external appearance of an ultraviolet irradiation device of this embodiment is similar to that of the first embodiment (see FIG. 2). FIG. 8 is a vertical cross-sectional view of a treatment vessel thereof. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7 (7a, 7b, 7c, and 7d); ultraviolet monitor windows 12; protection covers 14; ribs 15; rotation prevention shafts 55 (55a, 55b, 55c, and 55d); cleaning brushes 19 (19a, 19b, 19c, and 19d); cleaning plates 20 (20a and 20b); and drive shafts 21 (21a and 21b). The cleaning brushes 19 and the cleaning plates 20 constitute a cleaning mechanism. Note that the treatment vessel 6, the water supply port 9, the water discharge port 11, the protection tubes 7, the ultraviolet monitor windows 12, the protection covers 14, and the ribs 15 are to the same as those of the first embodiment in terms of configuration and function, and therefore their descriptions are omitted. Note also that since four protection tubes 7 are provided, they are denoted by 7a, 7b, 7c, and 7d, respectively. Like the protection tubes 7, the rotation prevention shafts 55, the cleaning brushes 19, the cleaning plates 20, and the drive shafts 21 are denoted by their reference signs and corresponding suffixes added thereto.

The cleaning brushes 19 are disposed in contact with the outer circumferences of the protection tubes 7. The cleaning brushes 19 wipe off dirt adhering to the outer circumferential surfaces (outer surface) of the protection tubes 7. The cleaning brushes 19a, 19b, 19c, and 19d clean the outer surfaces of the protection tubes 7a, 7b, 7c, and 7d, respectively.

The cleaning plates 20 are members of an elliptical plate shape with the cleaning brushes 19 being attached thereto. The cleaning plates 20 are disposed inside the treatment vessel 6 perpendicularly to the protection tubes 7. In each cleaning plate 20, there are formed two holes to be penetrated by the protection tubes 7, two holes to be penetrated by the rotation prevention shafts 55, and one hole to be penetrated by the drive shaft 21. Moreover, a spiral groove is formed in the inner wall surface of the hole to be penetrated by the drive shaft 21.

Note that the cleaning brushes 19a and 19b are attached to the cleaning plate 20a, and the plurality of holes to be penetrated by the protection tubes 7a and 7b, the rotation prevention shafts 55a and 55b, and the drive shaft 21a are formed in the cleaning plate 20a. Likewise, the cleaning brushes 19c and 19d are attached to the cleaning plate 20b, and the plurality of holes to be penetrated by the protection tubes 7c and 7d, the rotation prevention shafts 55c and 55d, and the drive shaft 21b are formed in the cleaning plate 20b.

A spiral groove is formed in an outer circumferential portion of each drive shaft 21. The spiral groove in the drive shaft 21 is threadedly engaged with the spiral groove in the corresponding hole of the cleaning plate 20. Moreover, the drive shaft 21 penetrates through the cleaning plate 20 in the vicinity of the center thereof and is provided along the direction parallel to the protection tubes 7. Furthermore, both end portions of the drive shaft 21 are rotatably attached to the side faces 6a and 6c of the treatment vessel 6, respectively. Note that the drive shaft 21a penetrates through the cleaning plate 20a while the drive shaft 21b penetrates through the cleaning plate 20b.

The pairs of rotation prevention shafts 55 have a bar shape and are each provided inside the treatment vessel 6 along the direction parallel to the protection tubes 7 (direction B). Moreover, both end portions of each rotation prevention shaft 55 are firmly fixed to the inner walls of the side faces 6a and 6c of the treatment vessel 6 (see FIG. 3), respectively. Furthermore, the rotation prevention shaft 55 penetrates through its cleaning plate 20 on the water outlet side in the direction A to prevent rotation of the cleaning plate 20. Note that the rotation prevention shafts 55a and 55b penetrate through the cleaning plate 20a, while the rotation prevention shafts 55c and 55d penetrate through the cleaning plate 20b.

Now, the cleaning plates 20 including the cleaning brushes 19 will be described further. To clean the protection tubes 7, the drive shafts 21 are rotated to move the cleaning plates 20 in a direction parallel to the axes of the protection tubes 7. During this process, the rotation prevention shafts 55 prevent the rotation of the cleaning plates 20 since the rotation prevention shafts 55 are penetrating through the cleaning plates 20. Then, as the cleaning plates 20 are moved in the direction parallel to the axes of the protection tubes 7, the cleaning brushes 19 wipe off dirt adhering to the outer surfaces of the protection tubes 7.

Moreover, the rotation prevention shafts 55 suppress the deformation of the treatment vessel 6, meaning that the rotation prevention shafts 55 suppress the deformation of the treatment vessel 6 due to a pressure increase inside the treatment vessel 6. As a result, the breakage of the protection tubes 7 and the ultraviolet lamps 8 can be prevented. In other words, the rotation prevention shafts 55 prevent the rotation of the cleaning plates 20 and also function as support members which suppress the deformation of the treatment vessel 6.

Moreover, the four rotation prevention shafts 55 are provided on the water outlet side (water discharge port 11 side) of the four protection tubes 7 in the direction A, respectively. Specifically, in a case where the treatment target water flows from the water supply port 9 toward the water discharge port 11, each rotation prevention shaft 55 is disposed downstream of its corresponding protection tube 7. In other words, the rotation prevention shaft 55 is disposed between the protection tube 7 and the water outlet in the first direction. Like the first embodiment, this is for irradiating ultraviolet rays from the ultraviolet lamp 8 to the treatment target water before turbulence is generated.

Moreover, an outside diameter Dₒ of each rotation prevention shaft 55 satisfies (formula 1) (see the first embodiment) so that turbulence generated by the flow of the treatment target water will not vibrate and break the rotation prevention shaft 55.

In the ultraviolet irradiation device of this embodiment configured as described above, the treatment target water first flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the fifth embodiment, the rotation prevention shafts 55 having the predetermined outside diameter are each disposed in parallel to the protection tubes 7 on a side closer to the water discharge port 11 (downstream side) than the corresponding protection tube 7 is. Thus, the rotation prevention shafts 55 prevent the rotation of the cleaning plates 20 and also suppress the deformation of the treatment vessel 6 due to a pressure increase inside the treatment vessel 6. As a result, the breakage of the protection tubes 7 housing the ultraviolet lamps 8 can be prevented.

### Sixth Embodiment

In this embodiment, rails which prevent rotation of members serve also as the support members.

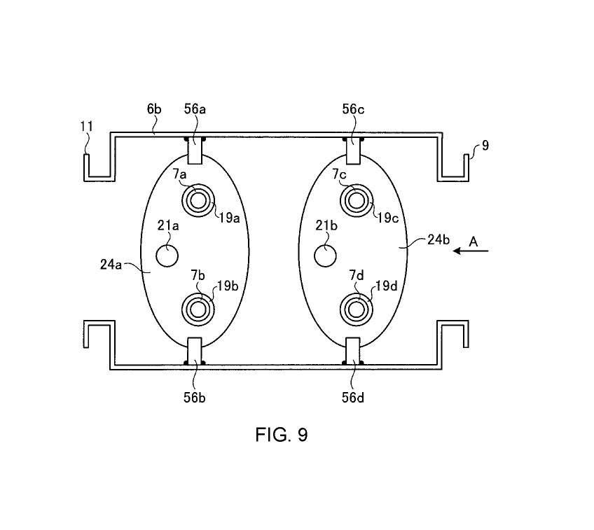

The external appearance of an ultraviolet irradiation device of this embodiment is similar to that of the first embodiment (see FIG. 2). FIG. 9 is a vertical cross-sectional view of a treatment vessel thereof. The ultraviolet irradiation device of this embodiment sterilizes, disinfects, and inactivates treatment target water in water supplies and sewages. The ultraviolet irradiation device mainly includes: a treatment vessel 6 which the treatment target water flows through; a water supply port 9; a water discharge port 11; protection tubes 7 (7a, 7b, 7c, and 7d); ultraviolet monitor windows 12; protection covers 14; ribs 15; rails 56 (56a, 56b, 56c, and 56d); cleaning brushes 19 (19a, 19b, 19c, and 19d); cleaning plates 24 (24a and 24b); and drive shafts 21 (21a and 21b). The cleaning brushes 19 and the cleaning plates 24 constitute a cleaning mechanism. Note that the treatment vessel 6, the water supply port 9, the water discharge port 11, the protection tubes 7, the ultraviolet monitor windows 12, the protection covers 14, and the ribs 15 are to the same as those of the first embodiment in terms of configuration and function, and therefore their descriptions are omitted. Moreover, the cleaning brushes 19 (19a, 19b, 19c, and 19d) are to the same as those of the fifth embodiment in terms of configuration and function, and therefore their descriptions are omitted. Note also that since four protection tubes 7 are provided, they are denoted by 7a, 7b, 7c, and 7d, respectively. Like the protection tubes 7, the rails 56, the cleaning brushes 19, the cleaning plates 24, and the drive shafts 21 are denoted by their reference signs and corresponding suffixes added thereto.

The cleaning plates 24 are members of an elliptical plate shape with the cleaning brushes 19 being attached thereto. The cleaning plates 24 are disposed inside the treatment vessel 6 perpendicularly to the protection tubes 7. In each cleaning plate 24, there are formed two holes to be penetrated by the protection tubes 7 and one hole to be penetrated by the drive shaft 21. Moreover, a spiral groove is formed in the inner wall surface of the hole to be penetrated by the drive shaft 21.

Note that the cleaning brushes 19a and 19b are attached to the cleaning plate 24a, and the plurality of holes to be penetrated by the protection tubes 7a and 7b and the drive shaft 21a are formed in the cleaning plate 24a. Likewise, the cleaning brushes 19c and 19d are attached to the cleaning plate 24b, and the plurality of holes to be penetrated by the protection tubes 7c and 7d and the drive shaft 21b are formed in the cleaning plate 24b.

A spiral groove is formed in an outer circumferential portion of each drive shaft 21. The spiral groove in the drive shaft 21 is threadedly engaged with the spiral groove in the corresponding hole of the cleaning plate 24. Moreover, the drive shaft 21 penetrates through the cleaning plate 24 in the vicinity of the center thereof and is provided along the direction parallel to the protection tubes 7. Furthermore, both end portions of the drive shaft 21 are rotatably attached to the side faces 6a and 6c of the treatment vessel 6, respectively. Note that the drive shaft 21a penetrates through the cleaning plate 24a while the drive shaft 21b penetrates through the cleaning plate 24b.

Each rail 56 is attached to the inner wall of the upper face 6b or the lower face 6d of the treatment vessel 6. The longitudinal direction of the rail 56 is set in the direction parallel to the protection tubes 7 (direction B). The rail 56 supports its corresponding cleaning plate 24. Moreover, both end portions of the rail 56 are firmly fixed to the inner walls of the side faces 6a and 6c of the treatment vessel 6 (see FIG. 3), respectively. Furthermore, the rail 56 guides the cleaning plate 24 in such a way as to move the cleaning plate 24 in the direction parallel to the protection tubes 7 (direction B), and also prevents rotation of the cleaning plate 24. Note that the rail 56a is attached to the upper face 6b while the rail 56b is attached to the lower face 6d, and they guide the cleaning plate 24a. The rail 56c is attached to the upper face 6b while the rail 56d is attached to the lower face 6d, and they guide the cleaning plate 24b.

Now, the cleaning plates 24 including the cleaning brushes 19 will be described further. To clean the protection tubes 7, the drive shafts 21 are rotated to move the cleaning plates 24 in a direction parallel to the axes of the protection tubes 7. During this process, the rails 56 guide the movement of the cleaning plates 24 and also prevent the rotation of the cleaning plates 24. Then, as the cleaning plates 24 are moved in the direction parallel to the axes of the protection tubes 7, the cleaning brushes 19 wipe off dirt adhering to the outer surfaces of the protection tubes 7.

Moreover, the rails 56 suppress the deformation of the treatment vessel 6, meaning that the rails 56 suppress the deformation of the treatment vessel 6 due to a pressure increase inside the treatment vessel 6. As a result, the breakage of the protection tubes 7 and the ultraviolet lamps 8 can be prevented. In other words, the rails 56 guide the movement of the cleaning plates 24 and also prevent the rotation of the cleaning plates 24. Further, the rails 56 also function as support members which suppress the deformation of the treatment vessel 6.

In the ultraviolet irradiation device of this embodiment configured as described above, the treatment target water first flows through the treatment vessel 6 in the direction A after flowing in through the water supply port 9. Then, bacteria in the treatment target water are sterilized, disinfected, and inactivated by the ultraviolet rays 10 emitted from the ultraviolet lamps 8 housed in the protection tubes 7. The treated water is then discharged through the water discharge port 11.

As described above, in the ultraviolet irradiation device of the sixth embodiment, the rails 56 attached to the upper face 6b and the lower face 6d of the treatment vessel 6 are disposed in parallel to the protection tubes 7. Thus, the rails 56 guide the movement of the cleaning plates 24 and also prevent the rotation of the cleaning plates 24. Further, the rails 56 suppress the deformation of the treatment vessel 6 due to a pressure increase in the treatment vessel 6. As a result, the breakage of the protection tubes 7 housing the ultraviolet lamps 8 can be prevented.

While some embodiments of the present invention have been described hereinabove, these embodiments are presented as mere examples and are not intended to limit the scope of the invention. These novel embodiments can be carried out in various different forms, and various omissions, replacements, and changes can be made without departing from the gist of the invention. These embodiments and their modifications are encompassed in the scope and gist of the invention and also encompassed in the scope of the inventions described in the scope of claims and equivalents thereof.

What is claimed is:

1. An ultraviolet irradiation device comprising:
a treatment vessel which has a water inlet and a water outlet and through which water to be treated as a treatment target flows in a first direction from the water inlet toward the water outlet, the treatment vessel receiving the water to be treated through the water inlet and discharging the water to be treated through the water outlet;
an ultraviolet irradiation member which is provided inside the treatment vessel along a second direction crossing the first direction and which irradiates the water to be treated flowing through the treatment vessel with an ultraviolet ray; and
a support member which is provided inside the treatment vessel along the second direction with both end portions of the support member being firmly fixed to wall surfaces of the treatment vessel.

2. The ultraviolet irradiation device according to claim 1, wherein the support member is provided between the ultraviolet irradiation member and the water outlet in the first direction.

3. The ultraviolet irradiation device according to claim 1, wherein the support member has a bar shape, and an outside diameter D₀ of the support member satisfies (formula 1):
Vr<1 (formula 1)
Reduced flow velocity (reference): Vr=U/(fₙ×D₀)
Average reference flow velocity: U=Qₘₐₓ/S_{d}
Natural Frequency: fₙ=(λ²)/(2πL²)×√(EI/(m+m_{w}))
Outside diameter of support member: D₀
Maximum flow velocity: Qₘₐₓ
Cross-sectional area of flow passage: S_{d}
Eigen value: λ=3.1415
Young's modulus of material of support member: E
Second area moment: I=π/64 (D₀⁴)
Length of support member: L
Mass per unit: m=Sρₛ
Removed mass per unit: m_{w}=S_{w}ρ_{w}
Cross-sectional area of support member: S
Density: ρₛ
Removed area: S_{w}=π(D₀/2)²
Water Density: ρ_{w}

4. The ultraviolet irradiation device according to claim 1, wherein the support member has a cylindrical shape, and an outside diameter D₀ and a thickness t of the support member satisfy (formula 2):
Vr<1 (formula 2)
Reduced flow velocity (reference): Vr=U/(fₙ×D₀)
Average reference flow velocity: U=Qₘₐₓ/S_{d}
Natural Frequency: fₙ=(λ²)/(2πL²)×√(EI/(m+m_{w}))
Outside diameter of support member: D₀
Maximum flow velocity: Qₘₐₓ
Cross-sectional area of flow passage: S_{d}
Eigen value: λ=3.1415
Young's modulus of material of support member: E
Second area moment: I=π/64(D₀⁴)
Length of support member: L
Mass per unit: m=Sπₛ
Removed mass per unit: m_{w}=S_{w}ρ_{w}
Cross-sectional area of support member: S=π(D₀/2)²−π(Dᵢₙ/2)²
Inside diameter of support member: Dᵢₙ=D₀−2 t
Thickness of support member: t
Density: ρₛ
Removed area: S_{w}=π(D₀/2)²
Water Density: ρ_{w}

5. The ultraviolet irradiation device according to claim 4, wherein the support member has a pipe shape, and a wire through which to supply power to the ultraviolet irradiation member penetrates through inside of the support member.

6. The ultraviolet irradiation device according to claim 1, wherein
the treatment vessel has a rectangular parallelepiped shape, and
the support member has a rectangular plate shape with long sides of the support member being provided along the second direction, and
two short sides of the support member are firmly fixed respectively to inner walls of two opposite first side faces of the treatment vessel extending in the first direction, while one of the long sides of the support member is firmly fixed to an inner wall of a second side face of the treatment vessel crossing the first side faces.

7. The ultraviolet irradiation device according to claim 6, wherein
the ultraviolet irradiation member is disposed closer to the water outlet in the first direction than the support member is,
the one long side of the support member is firmly fixed to the second side face in the vicinity of a center thereof in the first direction, and
the support member is disposed on a plane crossing a center axis of the ultraviolet irradiation member.

8. The ultraviolet irradiation device according to claim 1, further comprising a cleaning mechanism inside the treatment vessel, the cleaning mechanism including a cleaning part which cleans an outer circumferential surface of the ultraviolet irradiation member, wherein
the support member is a rotation prevention shaft penetrating through the cleaning mechanism to prevent rotation of the cleaning mechanism.

9. The ultraviolet irradiation device according to claim 1, further comprising a cleaning mechanism inside the treatment vessel, the cleaning mechanism including a cleaning part which cleans an outer circumferential surface of the ultraviolet irradiation member, wherein
the support member is a rail member,
the support member is firmly fixed to an inner wall surface of the treatment vessel along the second direction, and
the support member supports the cleaning mechanism movably in the second direction and prevents the cleaning mechanism from rotating.

10. The ultraviolet irradiation device according to claim 1, wherein the treatment vessel has a rectangular parallelepiped shape.
